(19) United States
(12) Patent Application Publication
(10) Pub. No.: US 2022/0276598 A1
(43) Pub. Date: Sep. 1, 2022

(54) CORRECTION FOR LOW GRAY COVERAGE PRINTING

(71) Applicant: Hewlett-Packard Development Company, L.P., Spring, TX (US)

(72) Inventors: Oron Ambar, Ness Ziona (IL); Haim Vladomirski, Ness Ziona (IL); Lior Monsonego, Kiryat-Gat (IL)

(73) Assignee: Hewlett-Packard Development Company, L.P., Spring, TX (US)

(21) Appl. No.: 17/637,615

(22) PCT Filed: Oct. 11, 2019
(86) PCT No.: PCT/US2019/055783

§ 371 Date: Feb. 23, 2022

(51) Int. Cl. G03G 15/00

(52) U.S. Cl. CPC G03G 15/5062

(57) ABSTRACT

Certain examples described herein relate to a method of electro-photographic printing. In an example a calibration image having one or more gray levels is printed using an optical element. The contrast of the printed calibration image is increased when the calibration image has a gray coverage below a threshold. The printed calibration image is scanned to determine adjustment factors for the optical element for the one or more gray levels. The adjustment factors are applied to the optical element when printing a non-calibration image.

### BACKGROUND

Some printing processes write multiple pixels simultaneously. For example, in a digital press using a liquid electro-photographic (LEP) process, laser elements may be used to write pixels onto a photo conductive medium, and multiple laser elements may be used in parallel.

### BRIEF DESCRIPTION OF THE DRAWINGS

Examples are further described hereinafter with reference to the accompanying drawings, in which:

FIG. 1 is a schematic diagram of a printing system according to an example;

FIG. 2 is a schematic diagram of a developer unit according to an example;

FIG. 3 is a schematic diagram of a printed image according to an example;

FIG. 4 is a flow chart illustrating a method of calibrating an imaging apparatus according to an example;

FIG. 5 is a flow chart illustrating a method of calibrating a contrast level for an imaging apparatus according to an example;

FIG. 6 is a schematic diagram of a processor and a computer readable storage medium with instructions stored thereon according to an example;

FIG. 7 illustrates a printed calibration image at normal and higher contrast levels according to an example.

### DETAILED DESCRIPTION

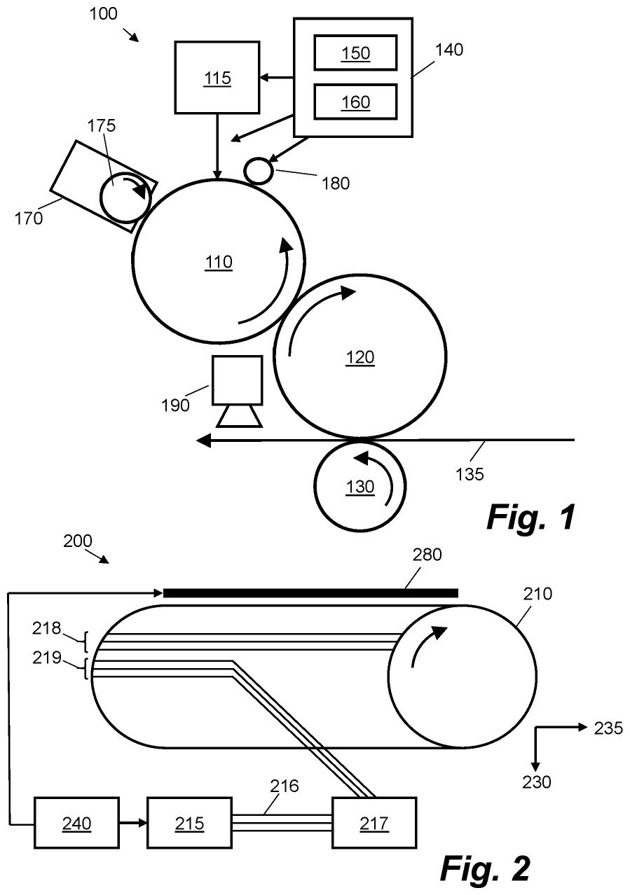

FIG. 1 shows a printing system 100 according to an example. Certain examples described herein may be implemented within the context of this printing system. However, it should be noted that implementations may vary from the example system of FIG. 1.

The printing system 100 may comprise a printer, for example a digital press printer. An example of a digital press printer is a digital offset press printer, for example a Liquid Electro-Photographic (LEP) printer. A digital offset printer works by using digitally controlled lasers or LED imaging modules to create a latent image on a charged surface of a photo imaging cylinder. The lasers are controlled according to digital instructions from a digital image file to create an electrostatic image on the charged photo imaging cylinder. Printing fluid such as ink is then transferred to the selectively discharged surface of the photo imaging cylinder, creating an inked image. The inked image is then transferred from the photo imaging cylinder to a heated blanket cylinder 120, where heating evaporates a liquid vehicle from the printing fluid, and finally from the blanket cylinder to a print medium 135.

In the example of FIG. 1, the printing system 100 comprises a photo imaging plate (PIP) 110. In the present example, the photo imaging plate 110 is mounted onto a cylinder. The cylinder may comprise a holder for attaching the leading edge of the photo imaging plate 110. In some examples, the trailing edge of the photo imaging plate 110 is also attached to the cylinder. In another example, the photo imaging plate 110 is mounted to a belt comprising a closed loop foil. In the present example, the mounted photo imaging plate 110 is rotatable about its axis in an anti-clockwise direction. In other examples, the photo imaging plate 110 is rotatable in a clockwise direction.

The photo imaging plate 110 rotates past a charge roller 106 which charges the PIP 110. In an example the PIP 110 is charged to −1000V, although other voltages may be employed. Lasers discharge different areas of the PIP to different voltages in order to create an electrostatic image corresponding to different intensities or gray levels of an image to be printed.

The printing system 100 comprises an exposure unit 115. The exposure unit 115 may comprise a number of optical elements each comprising a laser and which are controllable to generate the latent or electrostatic image on the photo imaging plate 110. The exposure unit 115 operates in accordance with received image data, otherwise referred to as “print data”, “input data”, “input image data”, “print input data”, or the like. The lasers may be arranged in an array. An array of lasers may be embodied as individual laser elements, as multiple channels of a single laser device, as a plurality of laser devices that each have multiple channels, etc.

The exposure unit 115 dissipates the static charges on selected portions of the surface of the photo imaging plate 110 to leave an electrostatic charge pattern that represents an image to be printed. Printing fluid such as ink is then transferred onto the photo imaging plate 110 by at least one ink developer unit 170. The ink developer units may comprise binary ink developer (BID) units, wherein each BID unit supplies ink of a different base color. The printing fluid may contain electrically charged pigment particles which are attracted to the image areas of the photo imaging plate 110. The printing fluid is repelled from the non-image areas. An inked image of the print frame is thereby transferred onto the photo imaging plate, i.e. a representation of the image formed from printing fluid.

The ink developer unit 170 has a developer roller 175 containing charged ink at a lower bias voltage than the initial charge of the PIP 110. Therefore, ink is repelled from areas of the PIP which have not been discharged by the lasers but are attracted to the PIP in areas where this has been fully or partially discharged in proportion to the difference in voltage between the ink on the developer roller 175 and the PIP. In an example the ink may be charged to −450V and the PIP 110 may initialed be charged to −1000V.

The printing system 100 also comprises a transfer member 120. In the present example, the transfer member 120 is cylindrical. However, in other examples, the transfer member may be other shapes, e.g. a belt. In the present example, the cylindrical transfer member 120 is rotatable about its axis in a clockwise direction. In other examples, the transfer member 120 is rotatable in an anti-clockwise direction. In an example, the transfer member 120 comprises a blanket wrapped around a surface of the transfer member 120. The transfer member 120 may be otherwise referred to as a blanket cylinder or an intermediate transfer member. The transfer member 120 is arranged to engage with the photo imaging plate 110. The transfer member 120 is configured to receive an inked image from the photo imaging plate 110. In the present example, the inked image is transferred from the photo imaging plate 110 to the transfer member 120 by rotating both the mounted photo imaging plate 110 and the transfer member 120 in opposite directions.

The printing system 100 also comprises a media transport 130. The media transport 130 is configured to move a print medium 135 relative to the transfer member 120 to enable the transfer member 120 to transfer an inked image onto the print medium 135. The media transport 130 is configured to engage with the transfer member 120 to enable the inked image to be transferred from the transfer member 120. The media transport 130 may be otherwise referred to as an impression cylinder or a pressure roller. The image may be transferred from the transfer member 120 to the print medium 135 as the print medium 135 passes to a nip between the transfer member 120 and the pressure roller 130.

The printing system 100 comprises a controller 140 which controls the exposure unit 115, the voltage applied to the PIP 110 by the charged roller 180 and/or the voltage applied to the ink on the developer roller 175.

The controller 140 comprises a memory 150. The memory 150 may comprise volatile and/or non-volatile memory. The memory 150 may comprise dynamic or static random access memories (DRAMs or SRAMs), erasable and programmable read-only memories (EPROMs), electrically erasable and programmable read-only memories (EEPROMs) and/or flash memories.

The memory 150 is to store a plurality of data structures. Each data structure comprises adjustment factors usable to adjust a plurality of optical elements, such as lasers, of the exposure unit 115. Different adjustment factors in a given data structure are usable to adjust different ones of the plurality of optical elements. Therefore, each of the plurality of optical elements in the exposure unit 115 may be independently adjustable using a corresponding adjustment factor.

Different data structures stored in the memory 150 correspond to different gray coverages in an image generated by the printing system 100. The data structures may be obtained by performing a calibration operation using a printed calibration image, as described below. In some examples, the gray coverages in the printed image correspond to a set of base gray levels. A set of base gray levels may comprise gray levels that are relatively coarsely spaced. Further gray levels that are not included in the set of base gray levels may be defined between different base gray levels.

In some examples, the adjustment factors of each of the data structures are based on a determined contribution of each of the plurality of optical elements to an optical property of the gray coverages in the printed image. In some examples, a calibration operation is performed using an exposed calibration image, such as an electrostatic image generated on the photo imaging plate 110.

The controller 140 also comprises a processor 160. Processor 160 can include a microprocessor, microcontroller, processor module or subsystem, programmable integrated circuit, programmable gate array, or another control or computing device.

The processor 160 is configured to determine gray levels for different image regions in input image data. A gray level for an image region may be determined by obtaining digital halftone values from the input image data and averaging the digital halftone values across the image region. In some examples, a gray level for an image region is determined by obtaining a set of optical power parameters for each pixel in the image region. The set of optical power parameters for each pixel may comprise four optical power parameters, although other numbers of optical power parameters may be used. An optical power parameter may relate to an optical power level. Determining the gray level for an image region may comprise averaging the optical power parameters across the pixels of the image region. In some examples, a gray level for an image region may be received. The gray level may be received from a further entity (not shown). An example of a further entity is an image generation controller. The gray level may be received as part of the input image data. The gray level may be received to enable the processor to obtain adjustment factors for the given image region. In some examples, a gray level for an image region is determined based on color values of pixels of the image region in the input image data. The color values may correspond to cyan, magenta, yellow (CMY) values.

The processor 160 is further configured to obtain adjustment factors for the different image regions. The adjustment factors for the different image regions are obtained by linking the determined gray levels to corresponding data structures within the plurality of data structures stored in the memory 150. In some examples, the processor 160 is configured to use a look-up table to map a determined gray level to a corresponding data structure.

In some examples, if a determined gray level for an image region is different from each of a set of base gray levels, the processor 160 is configured to interpolate adjustment factors between different data structures to obtain the adjustment factors for the image region. In some examples, a look-up table is used to indicate how to interpolate the adjustment factors between different data structures. For example, the determined gray level may be between a first base gray level and a second base gray level, the second base gray level being adjacent the first base gray level in the set of base gray levels. The processor 160 may use the look-up table to link the determined gray level to a first data structure corresponding to the first base gray level and a second data structure corresponding to the second base gray level. A number of interpolation points be used between data structures of consecutive base gray levels. For example, two, three or four interpolation points may be used. In addition to enabling the processor 160 to map a determined gray level to a data structure, the look-up table may indicate which interpolation point between consecutive data structures is to be used to obtain the adjustment factors for the image region.

In some examples, the determining of the gray levels and/or the obtaining of the corresponding adjustment factors for each image region is performed in real-time, for example during a print job.

The processor 160 is further configured to adjust the optical elements for each image region using the corresponding obtained adjustment factors to enable the generation of an exposed image using the exposure unit 115 based on the input image data. The exposed image may be generated by the plurality of optical elements in the exposure unit 115 based on control signals received from the optical controller 140.

In some examples, printing system 100 comprises a measurement unit 190 to measure an optical property of a printed image. For example, the measurement unit may comprise an in-line camera, in-line scanner, in-line spectrophotometer, or similar device. In other examples the measurement unit 190 may be separate from the printing system but configured to forward the printing system the optical properties of images printed by the printing system in order to calculate the adjustment factors, or to provide the adjustment factors directly.

FIG. 2 shows a printing system 200 according to an example. Some items depicted in FIG. 2 are similar to items shown in FIG. 1. Corresponding reference signs, incremented by 100, are therefore used for similar items.

Printing system 200 comprises a photo imaging plate 210 mounted on a rotatable cylinder. An exposure unit 215 comprising an array of lasers 216 is controlled by controller 240. The controller 240 is configured to obtain adjustment factors for the array of lasers 216 as described above. The controller 240 may also be configured to control the voltage of a charge roller 280 on order to control the bias voltage applied to the PIP 210.

Printing system 200 also comprises a polygon mirror 217. In some examples, the exposure unit 215 comprises the polygon mirror, for example as one of a plurality of optical elements of the exposure unit 215. In some examples, the polygon mirror 217 is separate from the exposure unit 215. The polygon mirror 217 may be configured to scan the array of lasers 216 across a surface of the photo imaging plate 210 in a scan direction 235, for example via rotation of the polygon mirror 217. The array of lasers 216 and the polygon mirror 217 may be arranged to write successive swathes 218, 219 across the surface of the photo imaging plate 210. FIG. 2 schematically shows a completed swathe 218 and a swathe in the process of being written 219. The mounted photo imaging plate 210 may rotate about its axis in order to allow successive swathes to expose different parts of the surface of the photo imaging plate 210. Rotation of the photo imaging plate 210 may correspond to a media transport direction 230, which may be perpendicular to the scan direction 235. Each swathe may have a number of lines equal to the number of lasers in the array. For simplicity, the array of lasers 216 shown in FIG. 2 comprises 3 lasers, however other numbers of lasers could be used, for example the array may include 12, 18, 28, 36 or 40 lasers.

In some examples, the array of lasers 216 may be scanned across the surface of the photo imaging plate 210 using means other than a polygon mirror, for example by using phased array scanning techniques, refractive optical components, acousto-optical deflectors or electro-optic deflectors.

The power received from a laser of the array 216 at the surface of the photo imaging plate 210 may vary across a swathe, in the scan direction 235, due to differences in the optical path as the lasers are scanned across the photo imaging plate 210, for example. Differences in the optical path may be due to the optical design or production tolerances of the optical elements being used. Further, the power received from a laser at the surface of the photo imaging plate 210 may vary between different swathes, for example due to variations in optical properties between different facets of polygon mirror 217. Variation in received laser power may lead to differences in the optical spot shape on the surface of the photo imaging plate 210 across a swathe and/or between different swathes. This may result in dot area non-uniformity in a printed image. This may, in turn, lead to visible artifacts in the printed image.

In some examples, individual laser elements of an array are controllable independently of image data. For example, a format correction feature may be provided that allows laser power to be varied along the scan direction. In some examples, format correction allows the power of each laser to be independently varied at intervals along the scan direction 235. In some examples, the intervals each correspond to 1 mm along the scan direction 235. In other examples, the intervals each correspond to 10 mm along the scan direction 235. In some examples, the format correction feature may be implemented by controlling a current provided to each laser element in each interval. In other examples, a pulse width of the laser is controlled instead of, or in addition to, the current provided to the laser. In some examples, the laser profile to be applied using format correction is controlled as 1^{st} or 2^{nd} order polynomials, with parameters of the polynomials being selected to reduce or minimize measured artifacts according to a trial-and-error approach. In some examples, a two-dimensional array or data structure indicative of the corrections to be applied to the lasers using format correction may be stored, for example to a file, and loaded on demand when format correction is to be applied. One dimension of the array may correspond to a location along a scan direction, and the other dimension of the array may correspond to the laser element in the array of laser elements. In some examples, such correction data comprises a third dimension corresponding to a facet of a polygon mirror. In one specific implementation, a given data structure comprises corrections for 40 lasers and 6 polygon facets at 100 predetermined locations along the scan direction. For a given pixel, a power of a laser element may be adjusted by a first correction factor and a second correction factor. The first correction factor corresponds to the laser element. The second correction factor corresponds to the polygon facet. For a given pixel that does not correspond to one of the predetermined locations along the scan direction, interpolation may be performed between correction factors for the locations that are the nearest neighbors of the given pixel.

Variation in received power between lasers may lead to a lack of uniformity in the final printed image. Optical power density non-uniformity may lead to non-uniformity of the dot area on the print medium. Non-uniformity between laser elements may lead to periodic disturbances in the final image, known as scan band artifacts. Such variation can be caused by differences between the individual laser elements or between different facets of a rotatable polygon mirror, but may also be caused by interference or crosstalk between the lasers during operation. Calibration of the lasers may be performed on individual lasers in an array. However, this may not address variation in laser output due to interference or crosstalk between the lasers, since this occurs when multiple lasers of the array are operated together and does not occur when the lasers are operated separately. Additionally, differences between optical characteristics of the lasers may contribute to dot area variation between lasers in a swathe. Furthermore, in order to achieve a high printed resolution, the number of lasers in an exposure unit may be increased, for example to 40 lasers, and the spacing between adjacent lasers in an array may be reduced. The density of screen coverages may also be increased in order to achieve a higher resolution. Consequently, interactions between different lasers and/or with the screen data can become complex and may lead to dot area variation between lasers and/or between different polygon facets being dependent on the gray level or coverage that is being used. In some examples, the banding profile of the array of lasers is different for different gray levels due to thermal effects and/or electrical cross-talk of the lasers. Dot area variation may be different for different gray levels but may not be directly proportional to the gray level being used, and therefore may not be obtainable via a constant or known factor. Banding artifacts for different gray levels are therefore difficult to predict due to the complexity of the interactions and effects of the simultaneously-used laser elements. In some examples, dot area variation between different polygon mirror facets also behaves differently for relatively sparse or relatively dense screen or gray coverages.

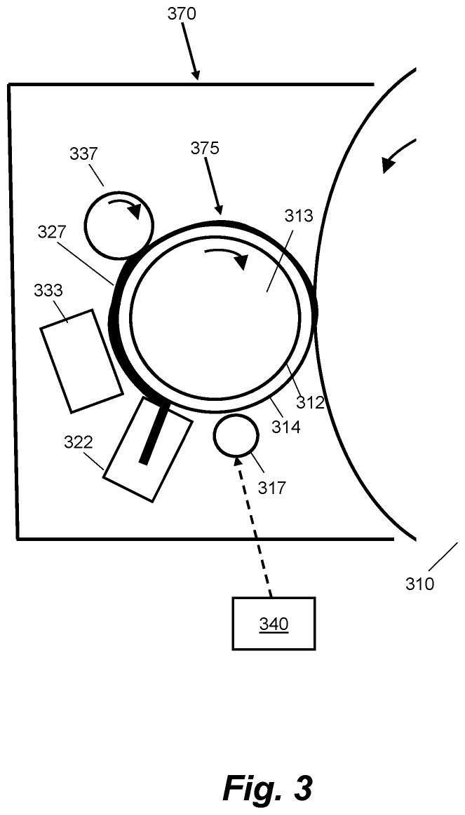

FIG. 3 shows an example ink developer unit in more detail. The ink developer unit 370 may be used in the example printing system 100 of FIG. 1 and corresponds to the ink developer 170 shown there and includes an ink developer roller 375 corresponding to the ink developer roller 175 shown in FIG. 1. The ink developer roller 375 or 175 is arranged to transfer ink to a photo imagining plate (PIP) 310, corresponding to 110 in FIG. 1. The voltage or charge on the ink developer roller 375 or 175 is controlled by controller 340 or 140 to adjust the level of ink transfer to the PIP and hence the contrast of the resulting printed image. This process is described in more detail below and is used to “boost” the contrast on low gray coverage calibration images to enhance their ability to be scanned accurately. This in turn allows more accurate adjustment factors to be determined and stored, for example in memory 150 or an equivalent memory in controller 340, and to be used for improved printing of non-calibration images having low gray coverage.

The developer roller 375 of the developer unit 370 includes a rubber roller 312 and a conductive core 313, and an electrical insulating exterior coating 314 around the roller 312. The exterior coating may have a thickness of between two and ten micros and may be fabricated from a (p-xylylene) polymer or another material. The developer unit 370 includes a charger roller 317 which may be controlled by a controller 340. The charger roller 317 is in contact with the exterior coating 314 and places a negative charge on the exterior coating 314 as the developer roller 375 rotates past the charger roller 317. Liquid ink 327 initially has a low percentage of solids such as resins and pigments. The liquid ink 327 can include negatively charged ink particles and counter charges in the form of positive micelles. The liquid ink 327, which thus has a zero total charge, is pumped within a channel 322 of the developer unit assembly 370, resulting in the negatively charged ink particles and positively charged micelles to separate due to an electric field between an electrode 333 and the developer roller 375. As the developer roller 375 rotates past the electrode 333, the exterior coating 314 thus receives negatively charged ink 327. That is, the electrode 333 is said to plate the negatively charged ink 327 onto the exterior coating 314.

The developer roller 375 continues to rotate towards a squeeze roller 337 of the assembly 370, which is in near contact with the exterior coating 314. After receiving the liquid ink 327 on the electrically insulating exterior coating 314, the developer roller 375 rotates past the squeeze roller 337. The squeeze roller 337 reduces a thickness of the liquid ink 327 on the exterior coating 314, which reduces the liquid content of the ink. The squeeze roller 337 compacts the ink 327 both mechanically and electrostatically. For example, the liquid content of the ink 327 may be reduced from about 80% as initially plated onto the exterior coating 314 to about 75% after passing against the squeeze roller 337.

The developer roller 375, with the reduced-thickness liquid ink 327 on its exterior coating 314, continues to rotate past the PIP 310 of the LEP printing device, which is rotating counterclockwise. The ink 327 is thus transferred to image (darker) portions of the electrostatic image formed on the PIP 310, as described above in relation to FIG. 1. The ink 327 is not transferred to the PIP 310 at background (lighter) portions of the image because there is more negative charge on the PIP 310 than on the developer roller 375 and because the resulting electric field is directed towards the PIP 310. The developer roller may then rotate past a cleaner roller (not shown) to remove any remaining ink from the exterior coating 314.

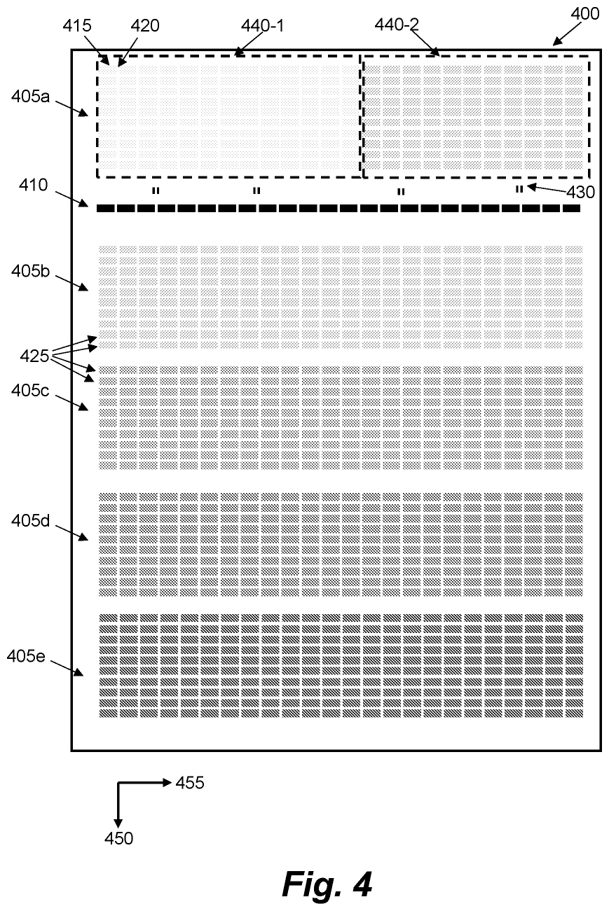

FIG. 4 shows a printed calibration image 400 according to an example. The printed calibration image 400 may be generated by printing system 100. Generating the calibration image 400 may involve controlling a plurality of laser elements of an optical exposure unit, such as exposure unit 115. The calibration image 400 may be generated as part of a calibration operation. The calibration operation may be performed in order to generate sets of corrections or adjustments to be applied to the plurality of laser elements.

The printed calibration image 400 comprises a plurality of calibration sections 405a, 405b, 405c, 405d, 405e. For simplicity, the calibration image 400 shown in FIG. 4 comprises five calibration sections, however other numbers of calibration sections could be used, for example the calibration image 400 may comprise 1, 3, 6, 7 or 8 calibration sections.

Each of the calibration sections 405a, 405b, 405c, 405d, 405e has one of a plurality of different base gray levels or gray coverage. A base gray level for a given calibration section may correspond to a gray coverage applied to the calibration section using the plurality of laser elements. For example, a relatively high laser output power may correspond to a relatively high gray coverage (e.g. a darker gray level), and a relatively low laser output power may correspond to a relatively low gray coverage (e.g. a lighter gray level). A laser element having a relatively high output power may cause a relatively high level of discharging on the charged surface of a photo imaging plate, thereby resulting in a darker gray printed image, and a laser element having a relatively low output power may cause a relatively low level of discharging on the photo imaging plate, thereby resulting in a lighter gray printed image. The output power of the laser elements may be adjusted by adjusting a pulse width and/or frequency of the laser elements. The phenomena which dominate non-uniformity affects may vary depending on the grey level, for example electrical crosstalk between lasers can dominate at low gray coverage and temperature may dominate at high gray coverage.

Each of the calibration sections 405a, 405b, 405c, 405d, 405e has a number of scan lines 425 corresponding to respective lasers in a swath, each controlled to print the same base gray level. The scan lines move across a page in a direction 455 perpendicular to the direction 450 of medium transport. The scan lines are divided into calibration portions or intervals 415, which may be 2 mm, 8 mm or 10 mm, or any suitable length. The calibration portions or intervals correspond to a scan angle of a laser, for example an angle of the polygon mirror. The intervals 415 may also be though of as a scan position along the swathe or PIP. The scan angles or positions may correspond to a respective adjustment factor to correct for laser non-uniformity when the printing system 100 is printing a non-configuration image.

In an example the lasers are switched off between intervals when printing the calibration image in order to compensate for variation exposure in the scanner 190. The areas 420 where the lasers are switched off may correspond to registration marks 420 which can be used by a measurement unit or scanner 190 to correctly align each interval 415. These registration marks may also correspond to a white area which can be used for normalizing measurements of an optical property (e.g. gray level) of the intervals, although other parts of the calibration image may be used for the white area measurement. In other examples, the scan lines may be continuous and the intervals adjacent each other. Where registration marks are used, the adjustment factors corresponding to those areas may be derived from the adjacent intervals.

A black scan line 410 is also printed to assist with normalization of measurements by a scanner 190. The calibration images may also use fiducials 430 with known locations on the calibration image 400 for aligning the scanner imaging with the calibration image.

Different calibration images may be used to determine an average adjustment factor for each base gray level for each interval. The different calibration images may have different combinations of lasers (and/or different facets of the polygon mirror) in use during printing so that the effect of different combinations of lasers (and/or different facets) may be incorporated into the calculation of adjustment factors.

FIG. 4 also illustrates schematically the use of higher contrast printing to increase the gray level of low gray coverage areas. As discussed previously this may be achieved by adjusting the voltage applied to a PIP and/or a developer unit roller. The calibration image 400 shown includes a low gray coverage section 405a which is shown printed with first or normal contrast in a first region 440-1 and second or increased contrast in a second region 440-2. This is shown merely to illustrate the concept of increasing the contrast of such low gray coverage sections or areas to help with the accuracy of subsequent scanning or measuring. In practice the entire calibration image would be printed with either normal or increased contrast. In an example, calibration images with only low gray coverage may be printed with increased contrast and calibration images with medium to high gray coverage may be printed with normal contrast on a separate printed image.

Calibration image 400 may be measured, for example by a measurement unit 190. Measuring the calibration image 400 may comprise measuring an optical property of the calibration portions in the calibration image 400. The measured optical property may include gray values of the image measured by an inline scanning device, for example. The measurement may include scanning an image and evaluating a gray value at each pixel of the scanned image. For example, where the scan has 8 bits per pixel, each pixel may have a value from 0 to 255, with 0 representing black and 255 representing white. In some examples, the scanning is performed in a 535×600 dots-per-inch mode (vertical×horizontal), although other scanning modes may be used in other examples.

The calibration image 400 may be printed without adjustment factors in order to determine these using differences in the measured gray levels with those of the base gray levels used to print the calibration image. In other examples, adjustment factors may be used to print the calibration image and the measured gray levels used to further refine the adjustment factors.

A profile of the measured grayscale data may be produced for each laser (corresponding to a scan line 425) for each interval 415 by averaging the measured pixel values along the scan direction 455 of each interval. The average values produce a profile corresponding to one-dimensional data representative of the variation in grayscale values along the scan direction 455.

In some examples, the measured property is used to evaluate a dot area ratio or a dot area percentage (DA %). For example, where a grayscale measurement renders values from 0 to 255, the following calculation may be performed for each interval 415:

DA %=(Interval_GL−White_GL)/(Black_GL−White_GL),
Where Interval_GL is the measured gray level of the current interval 415, White_GL is the measured gray level of the registration mark 420 or other predetermined area of the printed calibration image corresponding to white (e.g. image data gray level=255), and Black GL is the measured gray level of the black line 410 or another area of the printed calibration image corresponding to black (e.g. image data gray level=0).
In an example, corresponding to a base gray coverage of 40% (i.e. gray level is 149):
   Interval_GL=150, White_GL=251 and Black_GL=3 Giving DA %=0.40725, or measured gray coverage of 41%

The DA % calculated for each interval of a scan line 425 corresponding to each laser may then be used to determine an adjustment factor for that laser for the scan angle or image location corresponding to the respective interval. These adjustment factors can then be applied to the laser at the respective scan angle when printing a non-calibration image. Where multiple calibration images are used, the average DA % may be used for the adjustment factor calculation.

The adjustment factors may be based on the change in DA %, for example where the measured DA %=41% for a base gray coverage of DA %=40%, this represents a 1% increase in DA %. This may be adjusted using a 2.5% reduction in laser power, −2.5% being the adjustment factor applied to the laser at this base gray level at the scan angle corresponding to the measured interval 415. The correspondence between the change in DA % and the adjustment factor or power change applied to the laser may be different for different printing apparatus and may be determined for each printing apparatus by a preliminary calibration procedure. Other methods of determining the adjustment factors using the calculated DA % may alternatively be used. Methods of determining the adjustment factors using other optical property measurements or calculated values other than DA % may alternatively be used, for example spot size.

The above process may be performed for each of calibration sections 405a, 405b, 405c, 405d, 405e. Therefore, sets of corrections may be obtained for different base gray levels or coverage corresponding to the different coverages of calibration sections 405a, 405b, 405c, 405d, 405e. Sets of corrections for different base gray levels for different lasers for different scan angels may be stored as data structures, for example in memory, to be applied during a print job. Interpolations between base gray levels may be applied.

Measurement units such as the scanner 190 may have difficulty measuring accurate gray levels at low DA % or gray coverage areas which can result in inaccurate adjustment factors being applied for base gray levels (and interpolated gray levels) below certain gray coverage levels. For example, it has been found that gray coverage below 20% (i.e. gray levels above 204) can become difficult to measure accurately, whereas gray coverage above 20% can be measured robustly.

In an example, this can be handled by increasing the contrast of the printed calibration image so that the gray levels of light areas (highlights) can be more accurately measured. For example, for a base gray coverage of 10% (i.e. gray level of 229.5), the contrast of the printed calibration image may be doubled to obtain printed intervals corresponding to a base gray coverage of 20% (i.e. gray level of 204). These intervals are then measured by the scanner 190 as described above and variations or errors from the base grey coverage corresponding to 20% (204) are then identified and used to determine adjustment factors as previously described. These adjustment factors (e.g. 1% laser power reduction for a particular scan angle for a gray level of 229.5) are applied to a non-calibration image where the image data has a gray level of 229.5. Even though these adjustment factors are determined using increased contrast on the base gray overage of 10% effectively making this equivalent to a gray coverage of 20%, the obtained adjustment factors are still valid for printing at 10% gray coverage. As with the other base gray levels, interpolation may be used to determine adjustment factors for gray coverage in between base gray coverage adjustment obtained using the above increased contrast method.

In an example, the increased contrast may be achieved by increasing the (negative) voltage applied to the development roller 175, 375 and/or by reducing the (negative) voltage applied to the PIP 110, 210, 310. For example, the development roller voltage may be increased from −450V to −600V and/or the PIP voltage may be reduced from −1000V to −850V. A more detailed example for determining the voltage change is described below.

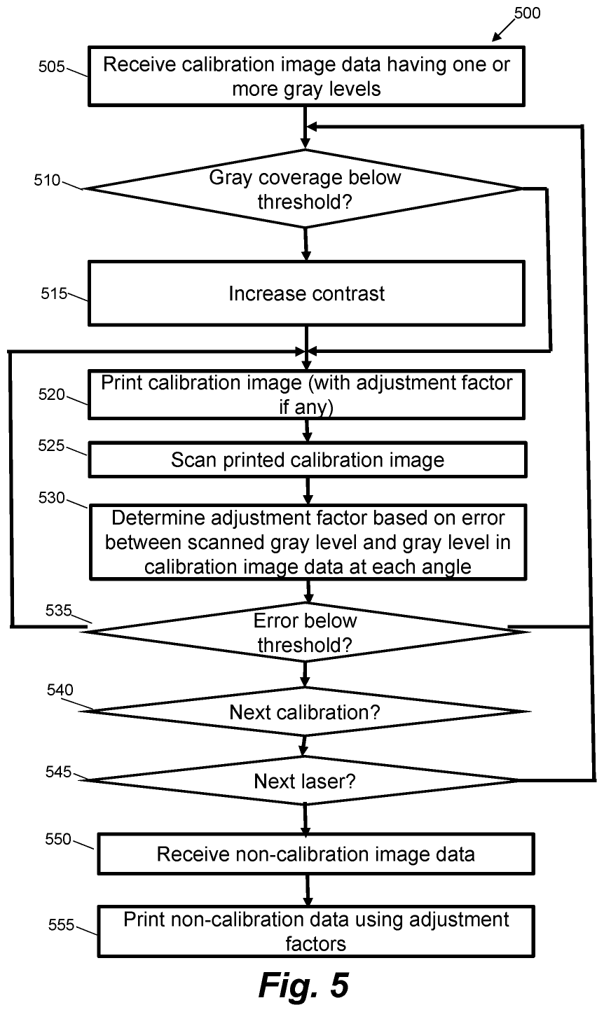

FIG. 5 shows a method 500 of electro-photographic printing according to an example. In some examples, the method 500 is performed by a controller such as controller 140, 240, 340. The optical controller may perform the method based on instructions retrieved from a computer-readable storage medium. The photo imaging plate may comprise photo imaging plate 110 and the developer unit may comprise developer unit 170.

At item 505, calibration image data having one or more gray levels is received. This may be in any suitable digital format usable by the printing apparatus to print a calibration image using optical elements having a laser, a photo imaging plate and a developer unit. The calibration image data corresponds to a printed calibration image such as calibration image 400 and has one or more base gray coverages (i.e. different areas with different gray levels) printed in intervals 415 along scan lines 425 corresponding to the optical elements.

The measured gray levels of each interval of the printed calibration image are then compared with the gray levels used in the calibration image data to determine differences or errors which are then used to determine adjustment factors for the optical elements when printing non-calibration images. More than one calibration image may be printed and measured, for example to determine adjustment factors for all base gray levels for a printing system, or to determine errors for different combinations of lasers for each base gray level in order to then determine adjustment factors when using each combination of lasers and/or to determine an average adjustment factor based on the different combinations of lasers.

At item 510, the method 400 determines when a base gray level in the received calibration image data has a gray coverage below a threshold, for example a gray coverage below 20% or a gray level greater than 204. It is noted that the phase “below a threshold” is intended to convey that the gray level meets a predetermined condition such as being below a predetermined DA % or above a grayscale number and corresponding to being below a predetermined intensity level. If the calibration image data to be printed contains gray coverage below the threshold then the method moves to item 515 where the contrast of the printing system is increased and the method moves to item 520. The contrast may be increased by increasing the voltage (charge) of the developer unit and/or reducing the voltage (charge) of the PIP as previously described, although other methods of increasing the contrast could alternatively be used. If the gray coverage(s) in received calibration image data are (all) above the threshold, then the method moves to item 520.

At item 520, the printed calibration image is printed using the received calibration image data. This may be implemented using increased contrast depending on the gray coverage of the calibration image data as previously described. The calibration image may initially be printed without any adjustment factors, but then in subsequent iterations may be printed with adjustment factors until an adequate rendering is achieved.

At item 525, the printed calibration image is scanned by a measurement unit to measure the gray values of each calibration portion 415 as previously described. At item 530, an adjustment factor is determined for each calibration portion 415 or scan angle for the current laser and current base gray level. This is based on the difference between the base gray level in the received calibration image data and the measured gray level and is determined as previously described.

At item 535, it is determined whether the error between the gray level in the image data and the gray level measured is below a threshold, for example less than a gray level of 1, less than 0.1% or some other suitable metric. If this is not the case, the method returns to item 520 where the calibration image is printed again but this time using the previously determined adjustment factors. The newly printed calibration image is scanned again, and the adjustment factors fine-tuned. Once the errors are below the threshold, the method moves to item 540.

At 540, it is determined whether another calibration is needed, for example another gray coverage or set of gray coverages. If so the same process of determining adjustment factors for this laser but at the different gray coverage is performed, including determining whether or not to increase the contrast when printing the calibration image. At 545, it is determined whether another laser of the printing system needs to be calibrated and if so the same process of determining adjustment factors for this new laser is performed. Once all of the lasers have been calibrated, the method moves to item 550.

At item 550, non-calibration image data is received. This may be any job data that is to be printed by the now calibrated printing system, for example pictures, labels or any customer job data.

At item 555, the non-calibration images are printed using the adjustment factors. For example, the power levels of the optical elements are adjusted by the adjustment factor for each scan angle, laser and gray level used to print each pixel of the image. It is noted that the non-calibration images are printed at normal contrast, not the increased contrast that may have been used in the calibration process. The adjustment factors determined using the increased contrast for low gray coverage (low DA % or high gray level) calibration image data is used for low gray coverage pixels of non-calibration images but without the increased contrast.

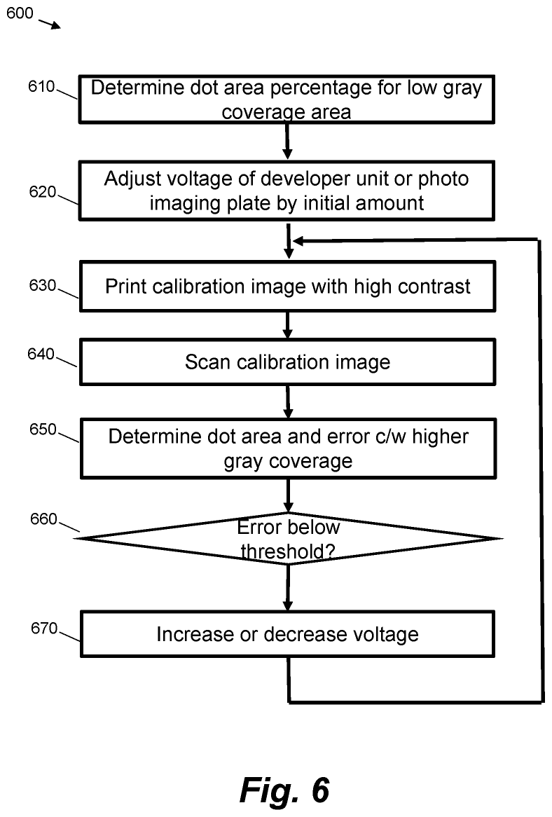

FIG. 6 shows a method 600 of increasing the contrast when calibrating an exposure unit for low gray coverage. In some examples, the method 600 is performed by a controller such as controller 140, 240, 340. The controller may perform the method based on instructions retrieved from a computer-readable storage medium. The method 600 may be performed prior to method 500 in order to determine the appropriate increased contrast for item 515.The method finds an appropriate contrast increase in order to increase the gray coverage of the calibration image so that it can be more accurately scanned.

At item 610, a dot area percentage is determined for the interval pixels in the calibration sections of the calibration image without increased contrast, for example DA %=10% or gray level=229.5. This DA % corresponds to a gray level that is below what can be robustly measured by a measurement unit.

At item 620, the contrast of the printing system is increased by adjusting the voltage of the developer unit or photo imaging plate by an initial amount, for example 150V. In an example, the developer unit may have its voltage increase from −450V to −600V and/or the PIP may have its voltage reduced from −1000V to −850V.

At item 630, the calibration image is printed with the increased contrast. Because of the higher contrast, the image will appear darker or to have higher gray coverage, for example the 10% gray coverage of the calibration image data will be printed closer to 20% gray coverage. The calibration image may be any suitable image with low gray coverage, for example calibration image 400.

At item 640, the printed calibration image is scanned as previously described. Because the gray coverage is greater in the printed image than the image data, the scanner will more accurately measure the gray levels. Using the above example, the scanner will detect gray levels closer to those of a gray coverage of 20%, rather than 10%.

At item 650, the dot area percentage DA % is determined based on the measured gray level using the previously described equation. Using the above example, the DA % may be determined as 23% which has an error of 3% compared with the desired 20%. At item 660, if the error is less than a threshold, for example 0.1%, then the method ends with the change in voltage applied to the PIP or developer unit being that used for the increased contrast (515) in the method 500 of FIG. 5. If the error is not below the threshold, the method moves to item 670.

At item 670, the voltage applied to the PIP and/or developer unit is increased or decreased depending on whether the error is above or below the wanted gray coverage. Using the above example, the DA % of 23% is 3% above the wanted DA % of 20% and so the voltage is reduced. The change of voltage may be dependent on the size of the error, for example the DA %=3% error of the above example represents a 15% correction needed and the voltage change may then be reduced by 15%, for example from 150V on the PIP to 127.5V; although other algorithms could alternatively be used. The method then returns to item 630 when the calibration image is printed again using the adjusted high contrast voltage. This process iterates until the error falls below the predetermined threshold.

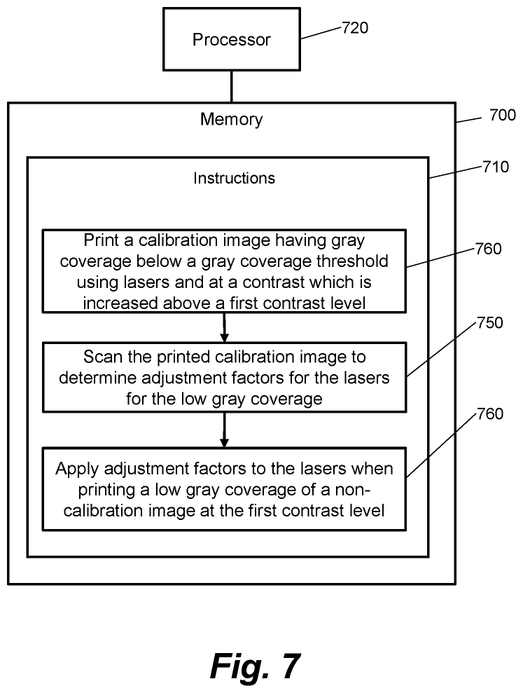

FIG. 7 shows a computer-readable storage medium 700, which may be arranged to implement certain examples described herein. The computer-readable storage medium 700 comprises a set of computer-readable instructions 710 stored thereon. The computer-readable instructions 710 may be executed by a processor 720 connectably coupled to the computer-readable storage medium 700. The processor 720 may be a processor of a printing system similar to printing system 100. In some examples, the processor 720 is a processor of a controller such as controller 140.

Instruction 740 instructs the processor 720 to print a calibration image having one or more gray levels and to increase the contrast when the calibration image has a gray coverage below a threshold. The calibration image may be printed using a plurality of laser elements writing onto a photo imaging plate. Instruction 750 instructs the processor 720 to scan the printed calibration image to determine corrections or adjustment factors for the lasers for the one or more gray levels. The adjustment factors are for adjusting the output of the plurality of lasers. In some examples, adjustment factors are based on a determined contribution of each of the plurality of lasers to an optical property in a printed image. Instruction 760 instructs the processor 720 to apply the adjustment factors or corrections to the lasers when printing a non-calibration image.

Processor 720 can include a microprocessor, microcontroller, processor module or subsystem, programmable integrated circuit, programmable gate array, or another control or computing device. The computer-readable storage medium 600 can be implemented as one or multiple computer-readable storage media. The computer-readable storage medium 700 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 710 can be stored on one computer-readable storage medium, or alternatively, can be stored on multiple computer-readable storage media. The computer-readable storage medium 700 or media can be located either in the printing system 100 or located at a remote site from which computer-readable instructions can be downloaded over a network for execution by the processor 720.

Certain examples described herein enable multiple sets of corrections to be applied to optical elements or lasers of a printing system for different regions in an image. The accuracy of these corrections for low gray coverage regions can be improved by determining these using a calibration image printed with increased contrast. The improved accuracy of the corrections for low gray coverage regions reduces visible printing artefacts such as banding.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of electro-photographic printing, the method comprising:
printing a calibration image having one or more gray levels using an optical element, wherein the contrast of the printed calibration image is increased when the calibration image has a gray coverage below a threshold;
scanning the printed calibration image to determine adjustment factors for the optical element for the one or more gray levels; and
applying the adjustment factors to the optical element when printing a non-calibration image.

2. The method of claim 1, wherein the contrast is increased by adjusting a voltage applied to a photo imaging plate and/or a developer unit.

3. The method of claim 2, wherein the contrast is increased by increasing the voltage applied to the developer unit.

4. The method of claim 2, wherein the contrast is increased by reducing the voltage applied to the photo imaging plate.

5. The method of claim 2, wherein the voltage adjustment is determined by comparing an optical parameter of an image having a predetermined gray coverage printed with increased contrast and the optical parameter of an image with a wanted gray coverage which is higher than the predetermined gray coverage.

6. The method of claim 5, wherein the optical parameter is a dot area percentage for the gray coverage levels.

7. The method of claim 1, wherein adjustment factors are determined for a plurality of scan angles and a plurality of gray levels for the optical element.

8. The method of claim 1, wherein the adjustment factors are determined for a plurality of optical elements each having a laser.

9. An electro-photographic imaging apparatus comprising:
an optical element to print an image in accordance with received image data;
a memory having adjustment factors for the optical element depending on the grey level of the received image data;
a processor to apply the adjustment factors to the optical element when printing a non-calibration image and to adjust a contrast of the apparatus when printing a calibration image having a grey coverage below a threshold voltage.

10. The apparatus of claim 9 comprising:
a photo imaging plate;
a plurality of optical elements each having a laser and controllable to generate a latent image on the photo imaging plate in accordance with the received image data;
a developer unit to apply a printing material to the photo imaging plate;
the processor to control a voltage applied to the photo imaging plate and/or the developer unit in order to adjust the contrast.

11. The apparatus of claim 9, the processor to increase the contrast by one or more of the following: increase the voltage applied to the developer unit; reduce the voltage applied to the photo imaging plate.

12. The apparatus of claim 9, the processor to:
control the apparatus to print a calibration image having a low gray coverage below a gray coverage threshold, wherein the contrast of the printed calibration image is increased above a first contrast level;
use scanned gray levels from the printed calibration image to determine adjustment factors for the optical element for the low gray coverage;
control the apparatus to apply the adjustment factors to the optical element when printing low gray coverage of a non-calibration image at the first contrast level.

13. The apparatus of claim 9 comprising a scanner to scan gray levels on a printed calibration image, the processor to determine corrections for the optical element for one or more gray levels using the scanned gray levels and corresponding gray levels in calibration image data used to print the printed calibration page.

14. A non-transitory computer-readable storage medium comprising a set of computer-readable instructions that, when executed by a processor, cause the processor to:
print a calibration image having gray coverage below a gray coverage threshold using lasers and at a contrast which is increased above a first contrast level;
scan the printed calibration image to determine adjustment factors for the lasers for the low gray coverage; and
apply the adjustment factors to the lasers when printing a low gray coverage of a non-calibration image at the first contrast level.
